(19) United States
(12) Patent Application Publication
(10) Pub. No.: US 2008/0263403 A1
(43) Pub. Date: Oct. 23, 2008

(54) Conversion of Mathematical Statements

(76) Inventor: Andrei Nikolaevich Soklakov, London (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/663,132

(22) PCT Filed: Sep. 19, 2005
(86) PCT No.: PCT/GB05/03593

§ 371 Date: Oct. 24, 2007

(30) Foreign Application Priority Data
Sep. 18, 2004 (GB) 0420793.2

(51) Int. Cl. G06F 11/07

(52) U.S. Cl. 714/38; 714/E11.021

(57) ABSTRACT

A method for computer-assisted conversion of mathematical statements from one data format to another and an apparatus for carrying out the method are particularly useful for computer recognition of visual images of mathematical statements. There are difficulties in converting a mathematical statement perfectly from, say, a hand-written document into a mathematical computer code, especially if scanning and recognition software is used. Errors may also occur where electronic documents are transmitted over noisy communications channels. To overcome these difficulties, the method comprises inputting to a computer a mathematical statement expressed by a binary relation operator in a data file in the first format; passing the file through a recognition means to convert the file with the statement to a different data format; partitioning the statement into mathematical blocks using the binary relation operators; checking a mathematical block against at least one other block using the analytic manipulation means; identifying errors found by the checking; and reporting the errors.

This invention relates to a method for computer-assisted conversion of mathematical statements from one data format to another and an apparatus for carrying out the method. It is particularly useful for computer recognition of visual images of mathematical statements.

Mathematical statements are fundamental to many aspects of science and engineering, and as such it is a requirement that they are absolutely correct when they appear in written or indeed any other form. An incorrect statement can result in a wrong prediction which cannot be tolerated. However, it is extremely difficult to convert a mathematical statement perfectly from, say, a hand-written document into a mathematical computer code, especially if scanning and recognition software is used. The complexity of mathematical statements together with scanning imperfections means that errors are almost impossible to avoid. This is particularly the case with long series of statements presented by professional mathematicians and students in hand-written format. Errors may also occur where electronic documents are transmitted over noisy communications channels.

Various proposals have been made for checking mathematical data and recognising and evaluating mathematical expressions. For example, US-A-2001 0043740 relates to a character recognition device that recognises and extracts tables from documents and converts the characters into data. If there is a word such as total or average in a row or column heading, it assigns an appropriate mathematical operator to the row or column, and then uses the operator to check the numerical data extracted. US-A-2004 0054701 relates to a pen-based and gesture-driven editing system for manipulating mathematical expressions. It includes a recogniser for expressions which can handle ambiguities, fragments and changes, using a parsing system to determine whether or not the expression is mathematically possible. U.S. Pat. No. 5,559,939 shows a method and apparatus for preparing a document containing mathematical notation. The notation is entered via an input device on a display screen, and the apparatus interprets the notation and stores the mathematical relationship between the terms in a standardised form. The apparatus then uses the relationships and stored data to evaluate the expression. In all of these proposals, however, the capability for processing mathematical statements is limited, as they are not able to recognize the mathematical validity of complex statements, so that they cannot check for errors in such statements.

According to a first aspect of the invention, a method for computer-assisted conversion of a mathematical statement from one data format to another comprises:
inputting to a computer a mathematical statement containing one or more binary relation operators in a data file in the first format;
passing the file through a recognition means to convert the file with the statement to a different data format;
partitioning the statement into mathematical blocks using the binary relation operators;
checking a mathematical block against at least one other block using an analytic manipulation means;
identifying errors found by the checking; and
reporting the errors.

Thus, after conversion of a file with the mathematical statement into a different format, errors in the statement can be identified, by partitioning the statement into blocks and then checking the blocks against each other. The mathematical validity of arbitrary and complex statements can therefore be verified. For example, if the statement to be checked contains blocks A and B separated by the equality sign, so A=B, where A and B may themselves be complex mathematical expressions, a check is made of A−B using the analytic manipulation means. If this is not equal to zero, then an error is identified and reported.

The binary relation operators are =, > and <(equals, greater than and less than) and the like.

The analytic manipulation means for checking may be a standard commercially-available software package such as Mathematica.

The method may also include, after identification of an error, determining the type of error by further checking, and reporting the correction needed.

For example, if A-B is not equal to zero, then a check of A+B may be done. If A+B=0, this indicates an incorrect sign (+ or −) in A or B, so that the correct sign may be used. Other checks may be made as appropriate.

The method is of particular use where a visual image of a statement is to be converted into a mathematical computer code. Then, the mathematical statement is input via scanning and/or recognition software, and the type of error identified may be used to review predictions given by the recognition routine, or to repeat the scanning and recognition routine with different control parameters to provide more accurate recognition.

According to a second aspect of the invention, apparatus for conversion of a mathematical statement from one data format to another comprises:
an input device for receiving a mathematical statement containing one or more binary relation operators in a data file in a first format;
a memory for storing the statement;
an output device for outputting the result of checking; and
a processor for checking the statement, including
recognition means for converting the data file with the statement to a different data format;
partitioning means for partitioning the statement into mathematical blocks using the binary relation operators;
checking means for checking a mathematical block against at least one other block using analytic manipulation means;
identifying means for identifying errors found by the checking means; and
reporting means for reporting the errors to the output device.

The apparatus therefore identifies and reports errors in a mathematical statement using the method of the first aspect of the invention.

The identifying means may also have means for changing the way that two blocks are checked against each other when an error is found, to identify the correction needed. The correction is then also reported by the reporting means.

The analytic manipulation means for checking preferably comprises a commercially-available software package such as Mathematica, running on the processor.

According to a third aspect of the invention, we provide computer programme control code adapted to carry out all the steps of the method of the first aspect on a computer.

An embodiment of the invention will now be described in detail.

To carry out the invention we provide a computer with the usual processor, memory, input and output devices. The computer is also able to access the functionality of a software package such as Mathematica (from Wolfram Research Inc.) and the functionality capable of data input in a graphic format (e.g. scanning, hand-writing data tablet and the like) and recognition software. Any other commercially-available software package with adequate capability of manipulation of mathematical expressions may be used instead of Mathematica.

As part of the invention the computer has means, in the form of software, enabling it to take a mathematical statement containing one or more binary relation operators such as =, > or < in one data format, convert it to another data format, partition it into blocks, pass the blocks to Mathematica for checking in a specified way, and then identify and report errors arising from the checking.

Suppose that the memory contains a file with a scanned image in a given data format of a handwritten note with a mathematical statement to be processed by the computer. Before the computer can do anything with the statement it must be converted into a line of computer code (that is, another data format) that is mathematically equivalent to the statement on the note. The recognition software is used to do this, but it often creates errors, if it cannot recognise the characters, or the mathematical statement is very complex. The invention assists in the detection and resolving of these errors in the conversion process.

As an example, look at the mathematical statement, as a sequence of expressions,

A=B=C= . . . =Z

where each letter A, B etc represents a complex mathematical expression, and each is equal to the others.

If this sequence is input to the computer from scanning and recognition software, or via a noisy communications channel, it may contain errors, so that it no longer represents a true mathematical statement. The invention detects and reports the errors, as follows.

Firstly, using the equality signs, the sequence is partitioned into equivalent mathematical blocks A, B, C, . . . Z. The blocks are then recombined into checkable elements such as (A−B), (B−C) . . . so that each block can be checked against at least one other block. Each element (A−B) . . . is then checked using Mathematica, by use of the command “Simplify [A−B]”. Clearly if A=B then A−B=0, so that if any of the elements (A−B) when checked are not equal to zero, a possible error is detected. If the mathematical statements are very complex, Mathematica may not be able to resolve A-B using the ‘simplify’ command, and will then return a non-zero answer, even if the statements are correct. However, the fact that a possible error is detected enables further checking to take place manually.

Thus, if Mathematica generates a non-zero result, the software of the invention identifies this as an error, and reports it to the computer's output device, usually a screen.

This procedure practically eliminates the possibility that scanning and/or recognition mistakes go unnoticed. The invention can then be used to improve the performance of the scanning/recognition software. For example, the error reported can be used to review predictions given by the recognition routine, or even enable the recognition routine to be repeated with different control parameters to ensure better recognition of any parts that caused an error message.

The means which identify an error may also provide for recombining the blocks producing the error in a different way, to identify the type of error made. Thus, if (A−B) is non-zero, the checkable element (A+B) is passed to Mathematica, with the command “Simplify [A+B]”. If the result of this is zero then there is a mistake in a + or − sign in A or B. The reporting means will then report the correction needed, and the identifying means may also include a correcting means to correct the error automatically.

Other common mistakes may also be checked for and corrected, for example, checking A/B (which should be 1 if A=B) can provide an indication of an incorrect coefficient.

It will be appreciated that, although the invention has been described as requiring the use of scanning and recognition software, as well as the checking software such as Mathematica, it need not use these, and could provide these functions itself.

It will also be appreciated that the invention can operate similarly if the statement contains > or < signs or other such binary relation operators defined by the user. Thus, if A>B, the command “Simplify [A−B]” will return a value greater than zero if the statement has been correctly converted.

1. A method for computer-assisted conversion of a mathematical statement from one data format to another comprising:
inputting to a computer a mathematical statement containing one or more binary relation operators in a data file in the first format;
passing the file through a recognition means to convert the file with the statement to a different data format;
partitioning the statement into mathematical blocks using the binary relation operators;
checking a mathematical block against at least one other block using the analytic manipulation means;
identifying errors found by the checking; and
reporting the errors.

2. A method according to claim 1, comprising binary relation operators selected from the group consisting of =, > and < (equals, greater than and less than).

3. A method according to claim 1, wherein the analytic manipulation means for checking is a standard commercially-available software package.

4. A method according to claim 3, comprising the software package is Mathematica.

5. A method according to claim 1, including after identification of an error, determining the type of error by further checking.

6. A method according to claim 5, further comprising reporting the correction needed.

7. A method according to claim 5, wherein the error is corrected automatically.

8. A method according to claim 1, wherein a visual image of a statement is to be converted into a mathematical computer code, and wherein the mathematical statement is input via scanning and/or other graphic data input device and/or recognition software, and the type of error identified is used to review predictions given by the recognition routine, or to repeat the scanning and recognition routine with different control parameters to provide more accurate recognition.

9. An apparatus for conversion of a mathematical statement from one data format to another comprising:
an input device for receiving a mathematical statement containing one or more binary relation operators in a data file in a first format;
a memory for storing the statement;
an output device for outputting the result of checking; and a processor for checking the statement, including
recognition means for converting the data file with the statement to a different data format;
partitioning means for partitioning the statement into mathematical blocks using the binary relation operators;
checking means for checking a mathematical block against at least one other block using analytic manipulation means;
identifying means for identifying errors found by the checking means; and
reporting means for reporting the errors to the output device.

10. An apparatus according to claim 9, wherein the identifying means comprises means for changing the way the two blocks are checked against each other when an error is found, to identify the correction needed.

11. An apparatus according to claim 10, wherein the correction is then also reported by the reporting means.

12. An apparatus according to claim 10, wherein the identifying means includes a correcting means for correcting the error automatically.

13. An apparatus according to claim 9, wherein the analytic manipulation means for checking preferably comprises a commercially-available software package running on the processor.

14. An apparatus according to claim 10, wherein the software package is Mathematica.

15. A computer-readable medium having thereon computer-executable instructions for performing the steps of the method of claim 1.
